(19) United States
(12) Patent Application Publication
(10) Pub. No.: US 2014/0092042 A1
(43) Pub. Date: Apr. 3, 2014

(54) ELECTRONIC DEVICE AND DISPLAY CHANGE METHOD

(71) Applicant: KABUSHIKI KAISHA TOSHIBA, Tokyo (JP)

(72) Inventors: Kyohei Matsuda, Ome-shi (JP); Yukihiro Suda, Tachikawa-shi (JP)

(73) Assignee: KABUSHIKI KAISHA TOSHIBA, Tokyo (JP)

(21) Appl. No.: 13/971,668

(22) Filed: Aug. 20, 2013

(30) Foreign Application Priority Data
Oct. 1, 2012 (JP) 2012-219716

(51) Int. Cl. G06F 3/041

(52) U.S. Cl. CPC G06F 3/041
USPC 345/173

(57) ABSTRACT

According to one embodiment, an electronic device includes a first housing for a touch-screen display, a second housing for a touchpad, the first housing being slidably connected to the second housing, a detector, and a change module. The detector is configured to detect an input operation on the touchpad, when the touchpad is exposed. The change controller is configured to change a direction of a content displayed on the touch-screen display based on detection of the input operation.

### CROSS-REFERENCE TO RELATED APPLICATIONS

This application is based upon and claims the benefit of priority from Japanese Patent Application No. 2012-219716, filed Oct. 1, 2012, the entire contents of which are incorporated herein by reference.

### FIELD

Embodiments described herein relate generally to an electronic device and a display change method.

### BACKGROUND

In recent years, tablet-type computers have been gaining in popularity, and are used in various situations. For example, in preliminary discussions with some other person, there is a case in which a tablet-type computer is caused to display various images, and a user of the tablet-type computer gives an explanation with reference to such images.

In preliminary discussions with some other person, when the user sits at a position facing the other person, the user, in some cases, turns the tablet-type computer toward the other person so that the other person may easily view the display screen, or the user executes an input operation on the tablet-type computer so that the direction of the screen may be changed in accordance with the position at which the other person sits.

As described above, conventionally, in order to make the screen, which is displayed on the tablet-type computer, easier to view, it is necessary to change the direction of disposition of the tablet-type computer, or to execute an input operation for changing the screen on the tablet-type computer.

Thus, if a time when the user shows the screen to the other person and a time when the user confirms the content of the screen occur frequently one after another, such a situation will occur each time that a work is needed for changing the direction of disposition of the tablet-type computer, or the displayed screen is hidden by the hand in order to perform an input operation on the tablet-type computer.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an external appearance of an electronic device according to an embodiment.

FIG. 2 is an exemplary perspective view illustrating an external appearance of the electronic device according to the embodiment.

FIG. 3 is an exemplary perspective view illustrating an external appearance of the electronic device according to the embodiment.

FIG. 4 is an exemplary perspective view illustrating an operation of changing the mode of the personal computer in the embodiment from a tablet mode to a laptop mode.

FIG. 5 is an exemplary view illustrating a system configuration of the personal computer in the embodiment.

FIG. 6 is an exemplary view illustrating a relationship between programs of the personal computer in the embodiment.

FIG. 7 is a view illustrating an example of a setup screen for setting setup data in the embodiment.

FIG. 8 is a flowchart illustrating display control corresponding to an input operation on a touchpad at a time of a photography mode in the embodiment.

FIG. 9 is a view for describing a concrete example of the embodiment.

FIG. 10 is an exemplary view illustrating a personal computer in FIG. 9.

FIG. 11 is a view for describing a concrete example of the embodiment.

FIG. 12 is an exemplary view illustrating a personal computer in FIG. 11.

### DETAILED DESCRIPTION

Various embodiments will be described hereinafter with reference to the accompanying drawings.

In general, according to one embodiment, electronic device comprises a first housing for a touch-screen display, a second housing for a touchpad, the first housing being slidably connected to the second housing, a detector, and a change module. The detector is configured to detect an input operation on the touchpad, when the touchpad is exposed. The change controller is configured to change a direction of a content displayed on the touch-screen display based on detection of the input operation.

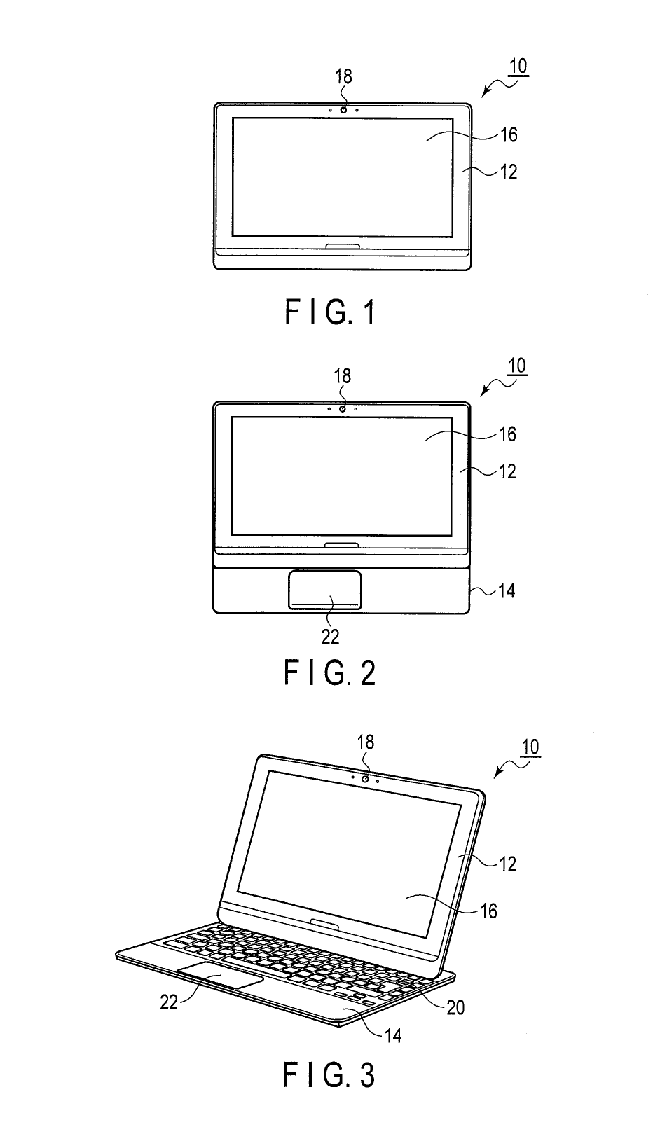

FIG. 1, FIG. 2 and FIG. 3 are views illustrating the external appearance of an electronic device according to an embodiment. The electronic device is realized, for example, as a personal computer 10.

The personal computer 10 in the embodiment is usable in three modes as shown in FIG. 1, FIG. 2 and FIG. 3. FIG. 1 is a plan view illustrating a tablet mode of the personal computer 10 in the embodiment. FIG. 2 is a plan view illustrating a photography mode of the personal computer 10 in the embodiment. FIG. 3 is a perspective view illustrating a laptop mode of the personal computer 10 in the embodiment.

The personal computer 10 includes a first housing 12 and a second housing 14. Each of the first housing 12 and second housing 14 has a thin box shape, and includes a first surface (top surface) and a second surface (back surface) which is opposed to the first surface.

The first housing 12 includes a touch-screen display 16 such that a display input surface of the touch-screen display 16 is exposed at a central part of the first surface. In addition, the first housing 12 is provided with a camera (Web camera) 18 near an outer periphery of the first surface. The touch-screen display 16 is constructed, for example, such that a touch panel is disposed on a display surface of an LCD (see FIG. 5).

The second housing 14 includes a keyboard 20 and a touchpad 22 in the first surface. The keyboard 20 is disposed on the rear side of the second housing 14 in a normal use state illustrated in FIG. 3. A front-side area of the first surface, where the keyboard 20 is not disposed, is used as a palm rest. The touchpad 22 is disposed in the palm rest. In the meantime, a part of the palm rest is used as an NFC (Near Field Communication) area which is capable of communicating with a wireless communication device stored in the second housing 14. In addition, a front-side partial range of the touchpad 22 functions as a touchpad control button.

The second housing 14 couples the first housing 12 to the first surface (top surface) thereof such that the first housing 12 is movable in the state in which the first housing 12 is laid over the first surface (top surface) of the second housing 14. FIG. 1 illustrates the state of the tablet mode in which the second surface of the first housing 12 and the first surface of the second housing 14 overlap each other such that these surfaces are substantially entirely opposed to each other. FIG. 2 illustrates the state of the photography mode in which the first housing 12 in the tablet mode is moved (slid) and the first housing 12 is set in such a position as to expose the touchpad 22. FIG. 3 illustrates the state of the laptop mode in which the first housing 12 is moved to such a position as to expose the touchpad 22 and keyboard 20, and the rear side of the first housing 12 is raised to such a position that the display input screen of the touch-screen display 16 faces the front side. The first housing 12 and second housing 14 are coupled by a hinge mechanism (not shown) so that the rear side of the first housing 12 may be raised in the position where the first housing 12 has been moved to the rear side of the second housing 14. The hinge mechanism is provided at such a position as to couple a part near a rear-side end portion of the first surface of the second housing 14 and a part near a front-side portion of the second surface of the first housing 12. The hinge mechanism is configured to make the first housing 12 rotatable within a predetermined range, relative to the second housing 14, from the state in which the first housing 12 is laid over the second housing 14. In the meantime, the personal computer 10 is provided with cables and connectors for electrically connecting the first housing 12 and second housing 14 in any of the modes (not illustrated).

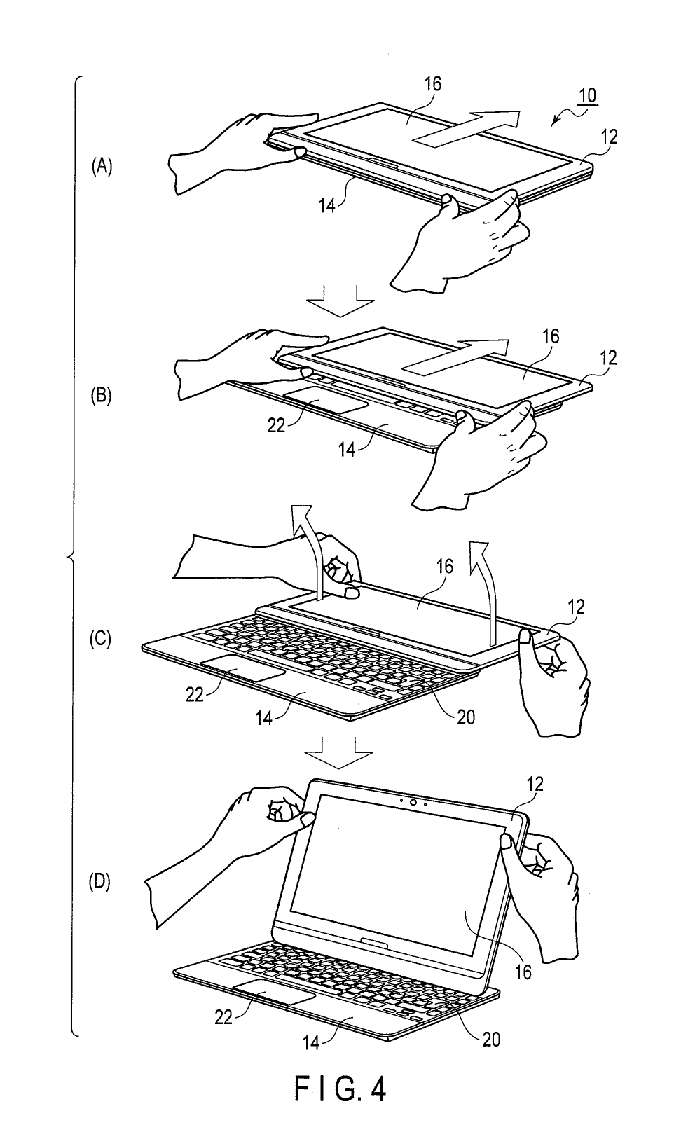

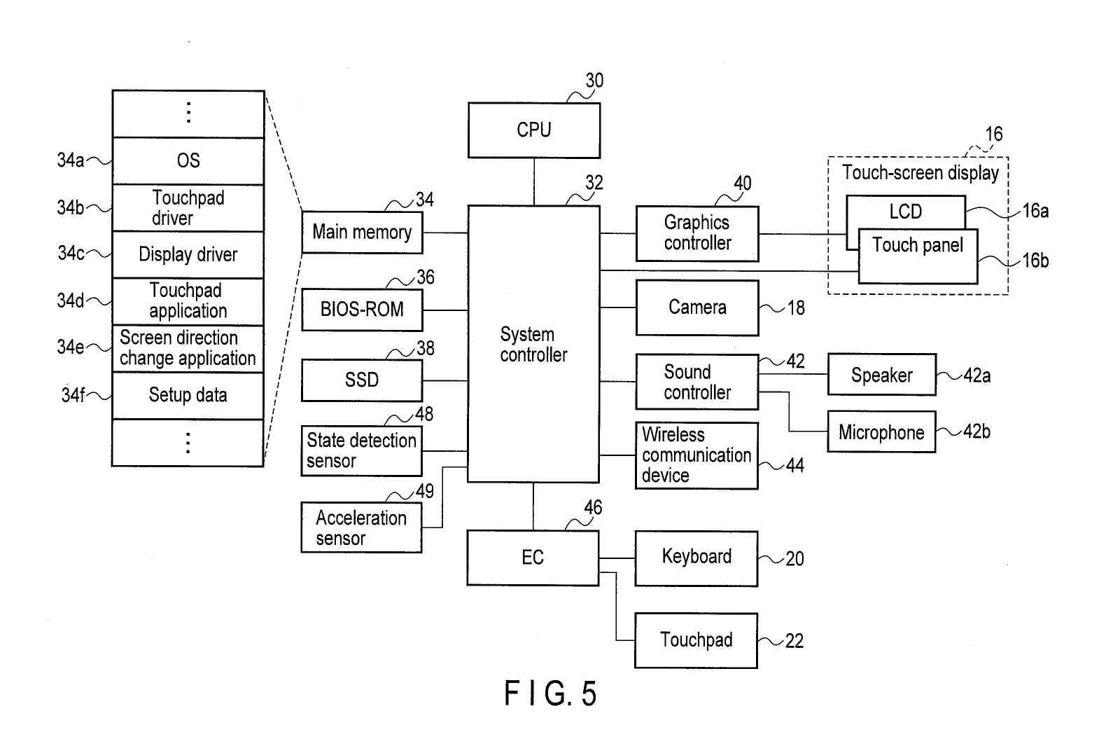

Parts (A) to (D) of FIG. 4 illustrate an operation of changing the mode of the personal computer 10 in the embodiment from the tablet mode to the laptop mode.

Part (A) of FIG. 4 illustrates the personal computer 10 in the tablet mode. In the tablet mode, the first housing 12 alone is slowly pushed rearward by using both hands, so that the position of disposition of the second housing 14 may not be moved. Thereby, the first housing 12 slowly moves along the second housing 14 in a direction of an arrow shown in part (A) of FIG. 4.

If the first housing 12 is moved and thereby the touchpad 22 of the second housing 14 is exposed, the mode of the personal computer 10 transitions to the photography mode. The personal computer 10 includes a holding mechanism which holds the first housing 12 in a position where the touchpad 22 is exposed, that is, in a position of the photography mode illustrated in FIG. 2. The state in which the first housing 12 is held by the holding mechanism is detected by a state detection sensor.

In the photography mode, if the first housing 12 is further pushed slowly in the rearward direction, the first housing 12 is disengaged from the holding mechanism. Thus, as illustrated in part (B) of FIG. 4, the first housing 12 can further be moved in the rearward direction. The first housing 12 can be moved to a position where a part near a rear-side end portion of the second housing 14 overlaps a part near a front-side end portion of the first housing 12. By being moved to the rearmost position, the first housing 12 is made rotatable by the hinge mechanism.

As illustrated in part (C) of FIG. 4, the rear side of the first housing 12 is raised in the position where the first housing 12 has been moved to the rear side of the second housing 14. Thereby, as shown in part (D) of FIG. 4, a transition occurs to the laptop mode. In the laptop mode, the first housing 12 is held by the hinge mechanism in the state in which the touch-screen display 16 faces the front side.

In many cases, the tablet mode is used at a time of executing, for example, an application in which the user directly touches and manipulates an object or the like, which is displayed on the touch-screen display 16. The photography mode is used at a time of executing an application in which a screen of photos, etc. is displayed on the touch-screen display 16 and is viewed. In the photography mode, display can be changed by an operation on the touchpad 22, so that the screen, which is displayed on the touch-screen display 16, may not be hidden by the hand by a touch operation on the touch-screen display 16. The laptop mode is a mode for use as a general personal computer. The laptop mode is used at a time of executing various applications using the keyboard 20 and touchpad 22.

FIG. 5 illustrates a system configuration of the personal computer 10 in the embodiment.

As shown in FIG. 5, the personal computer 10 includes a CPU 30, a system controller 32, a main memory 34, a BIOS-ROM 36, an SSD (Solid State Drive) 38, a graphics controller 40, a sound controller 42, a wireless communication device 44, an embedded controller (EC) 46, a state detection sensor 48, and an acceleration sensor 49.

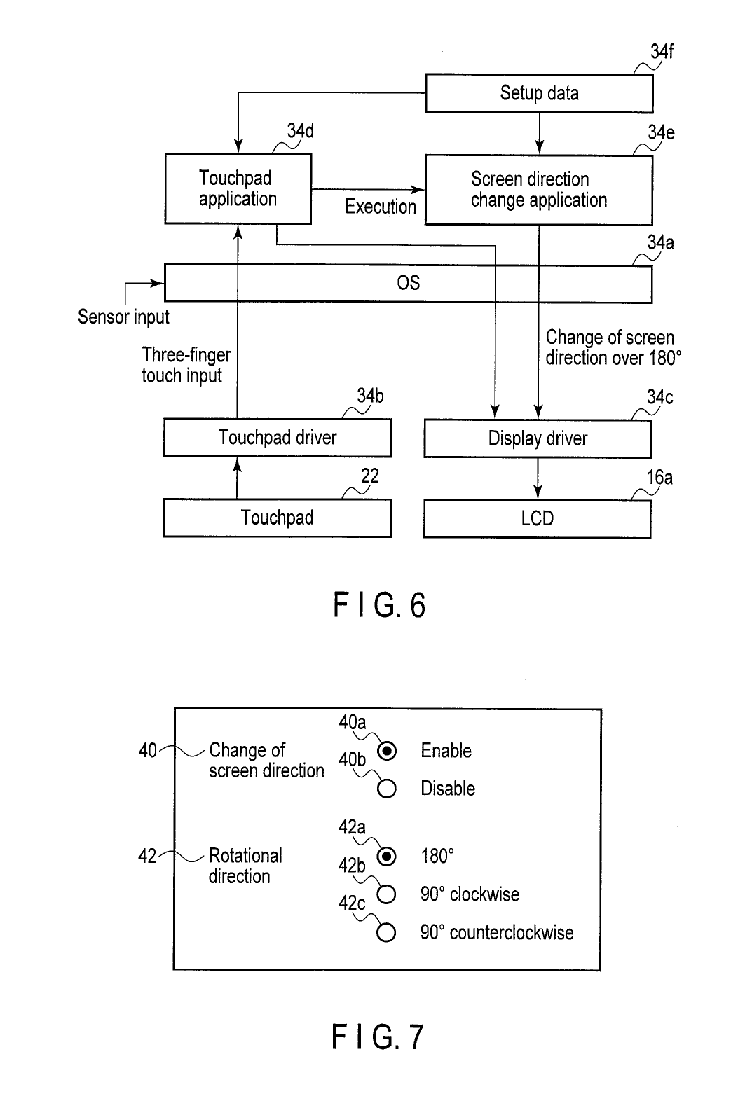

The CPU 30 is a processor which controls the operations of various modules mounted in the personal computer 10. The CPU 30 executes various programs, which are loaded from the SSD 38 which is a nonvolatile storage device into the main memory 34. The programs include an operating system (OS) 34a, a touchpad driver 34b, a display driver 34c, a touchpad application 34d, and a screen direction change application 34e. In addition, the CPU 30 refers to setup data 34f (to be described later in detail) which is stored in the main memory 34, when the touchpad application 34d and screen direction change application 34e are executed. The relationship between the respective programs will be described with reference to FIG. 6.

In addition, the CPU 30 executes a basic input/output system (BIOS) which is stored in the BIOS-ROM 36. The BIOS is a program for hardware control.

The system controller 32 is a device which connects the CPU 30 and various components. The system controller 32 includes a memory controller which access-controls the main memory 34. The BIOS-ROM 36, SSD 38, graphics controller 40, sound controller 42, wireless communication device 44, embedded controller 46, state detection sensor 48 and acceleration sensor 49, as well as the camera 18 and main memory 34, are connected to the system controller 32.

The graphics controller 40 controls an LCD 16a that is used as a display monitor of the personal computer 10. Under the control of the CPU 30, the graphics controller 40 sends a display signal to the LCD 16a. The LCD 16a displays a screen image based on the display signal. A touch panel 16b is disposed on the display surface of the LCD 16a. The touch panel 16b is, for example, an electrostatic capacitance-type pointing device for executing an input on the screen of the LCD 16a.

The sound controller 42 is a controller which processes an audio signal, and controls an audio output by a speaker 42a and an audio input from a microphone 42b.

The wireless communication device 44 is a device configured to execute wireless communication such as wireless LAN or 3G mobile communication, or to execute close proximity wireless transfer such as NFC (Near Field Communication).

The embedded controller 46 is a one-chip microcomputer including a controller for power management. The embedded controller 46 includes a function of powering on or powering off the personal computer 10 in accordance with an operation of a power button by the user. In addition, the embedded controller 46 controls inputs to the keyboard 20 and touchpad 22.

The state detection sensor 48 is a sensor for sensing the mode of the personal computer 10. The state detection sensor 48 detects, for example, that the first housing 12 is in the position of the photography mode (the position shown in FIG. 2).

The acceleration sensor 49 is a sensor for detecting a movement of the personal computer 10. The acceleration sensor 49 detects, for example, whether the touch-screen display 16 is in a horizontal state or a vertical state, when the user holds the personal computer 10 which is in the tablet mode. By detecting the direction of the touch-screen display 16 by the acceleration sensor 49, the direction of the content, which is displayed on the touch-screen display 16, can be changed.

Next, the relationship between the programs of the personal computer 10 in the embodiment is described with reference to FIG. 6.

The touchpad driver 34b is a driver for controlling an input on the touchpad 22. The touchpad driver 22 includes a function which is capable of multi-touch detection. The touchpad driver 34b notifies the OS 34a of data corresponding to an input operation on the touchpad 22. For example, when the number of touch positions on the touchpad 22 by the user is one, two, or three (or four or more), the touchpad driver 34b notifies the OS 34 of data indicative of the respective touch position(s).

Upon acquiring the data from the touchpad 22 through the OS 34a, the touchpad application 34d executes a process corresponding to this data through the OS 34a. The touchpad application 34d includes a registration function of registering an application, and can register the screen direction change application 34e by using this registration function.

For example, when data indicative of an input operation of touching the touchpad 22 at one touch position is input, the touchpad application 34d changes the display position of a pointer (cursor), which is displayed on the screen, in accordance with a change of the touch position. In addition, when data indicative of an input operation of touching the touchpad 22 at two touch positions is input, the touchpad application 34d scrolls the screen in accordance with a change of the touch positions. For example, when the touchpad 22 is touched by two fingertips and the two fingertips are moved in this state in a horizontal direction, the touchpad application 34d scrolls the screen in the horizontal direction.

In addition, when the screen direction change application 34e is registered in advance by the registration function, the touchpad application 34d can cause the screen direction change application 34e to execute a process corresponding to a predetermined input operation. For example, when data indicative of an input operation of touching the touchpad 22 at three touch positions is input, the touchpad application 34d changes the direction of the screen(content) via the screen direction change application 34e and OS 34a. In the meantime, when the personal computer 10 is in the photography mode and “enable” of a change of the direction of the screen by the screen direction change application 34e is set in the setup data 34f, the touchpad application 34d causes the screen direction change application 34e to execute a change of the screen. Incidentally, the setup data 34f will be described later (see FIG. 7).

In the meantime, responding to a notification from the state detection sensor 48, the OS 34a detects that the personal computer 10 is in the photography mode, and notifies the touchpad application 34d. When an input operation of touching the touchpad 22 at three touch positions has been executed in the photography mode, the touchpad application 34d causes the screen direction change application 34e to change the direction of the screen.

When an input operation of touching the touchpad 22 at three touch positions is executed, the screen direction change application 34e changes the direction of the screen that is displayed on the LCD 16a, in accordance with an instruction from the touchpad application 34d. The screen direction change application 34e determines a direction to which the direction of the screen is to be changed, by referring to the setup data 34f.

The display driver 34c causes the LCD 16a to display the screen corresponding to the notification from the OS 34a.

FIG. 7 is a view illustrating an example of a setup screen for setting the setup data 34f in the embodiment.

If a setup function by the screen direction change application 34e or a setup function by a purpose-specific utility program for setup is activated by an operation by the user, the computer 10 displays a setup screen shown in FIG. 7 on the touch-screen display 16 (LCD 16a).

On the setup screen, as shown in FIG. 7, there are provided select buttons 40a and 40b for selecting “enable” or “disable” of a screen direction change 40, and select buttons 42a, 42b and 42c for selecting a rotational direction 42. The select buttons 42a, 42b and 42c are made settable when the select button 40a, which is indicative of “enable” of the screen direction change, has been selected. For example, by selecting the select button 42a, such setting becomes possible that the direction of the original screen is changed by 180° (upside-down inversion) in response to an input operation at three touch positions. Similarly, the select button 42b can set a change of the direction of the screen over rotation over 90° clockwise, and the select button 42c can set a change of the direction of the screen by rotation over 90° counterclockwise.

The setup content on the setup screen is recorded as the setup data 34f, and is referred to when the touchpad application 34d and screen direction change application 34e are executed.

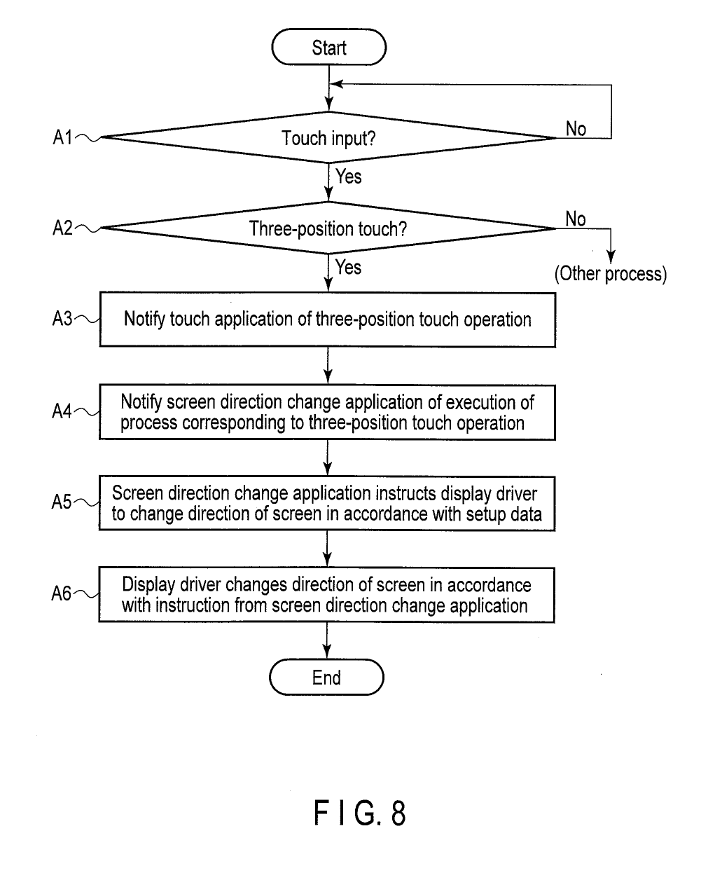

Next, referring to a flowchart of FIG. 8, a description is given of display control corresponding to an input operation on the touchpad 22 at the time of the photography mode in the embodiment.

When the first housing 12 has been shifted to the position of the photography mode, as shown in FIG. 2, the personal computer 10 detects this state by the state detection sensor 48. Responding to the detection by the state detection sensor 48, the OS 34a notifies the touchpad application 34d. Thereby, the touchpad application 34d executes a process corresponding to the photography mode.

In the photography mode, if an input operation is executed on the touchpad 22 by the user, the touchpad driver 34b detects a touch input to the touchpad 22 (Yes in block A1), and notifies the touchpad application 34d through the OS 34a.

If the input operation detected by the touchpad driver 34b is an input operation of touching the touchpad 22 at one touch position or two touch positions (No in block A2), the touchpad application 34d causes, via the OS 34a, the display driver 34c to execute a process corresponding to each input operation.

For example, if the detected input operation is an input operation of touching the touchpad 22 at one touch position, the display position of the pointer (cursor), which is displayed on the touch-screen display 16, is changed in accordance with a change of the touch position. In addition, if the detected input operation is an input operation of touching the touchpad 22 at two touch positions, the screen is scrolled in accordance with a movement of the touch positions.

On the other hand, if an input operation of touching the touchpad 22 at three touch positions has been detected (Yes in block A2), the touchpad driver 34b notifies, via the OS 34a, the touchpad application 34d that the input operation of touching the touchpad 22 at three touch positions has been executed (block A3).

Responding to the notification from the touchpad driver 34b, the touchpad application 34d instructs the screen direction change application 34e to execute the process corresponding to the input operation of touching at three positions, when the “enable” of the screen direction change is set in the setup data 34f (block A4).

In accordance with the instruction from the touchpad application 34d, the screen direction change application 34e instructs, via the OS 34a, the display driver 34c to change the direction of the screen in accordance with the rotational direction which is set in the setup data 34f (block A5).

The display driver 34c changes the direction of the screen displayed on the LCD 16a, in accordance with the instruction from the screen direction change application 34e (OS 34a) (block A6).

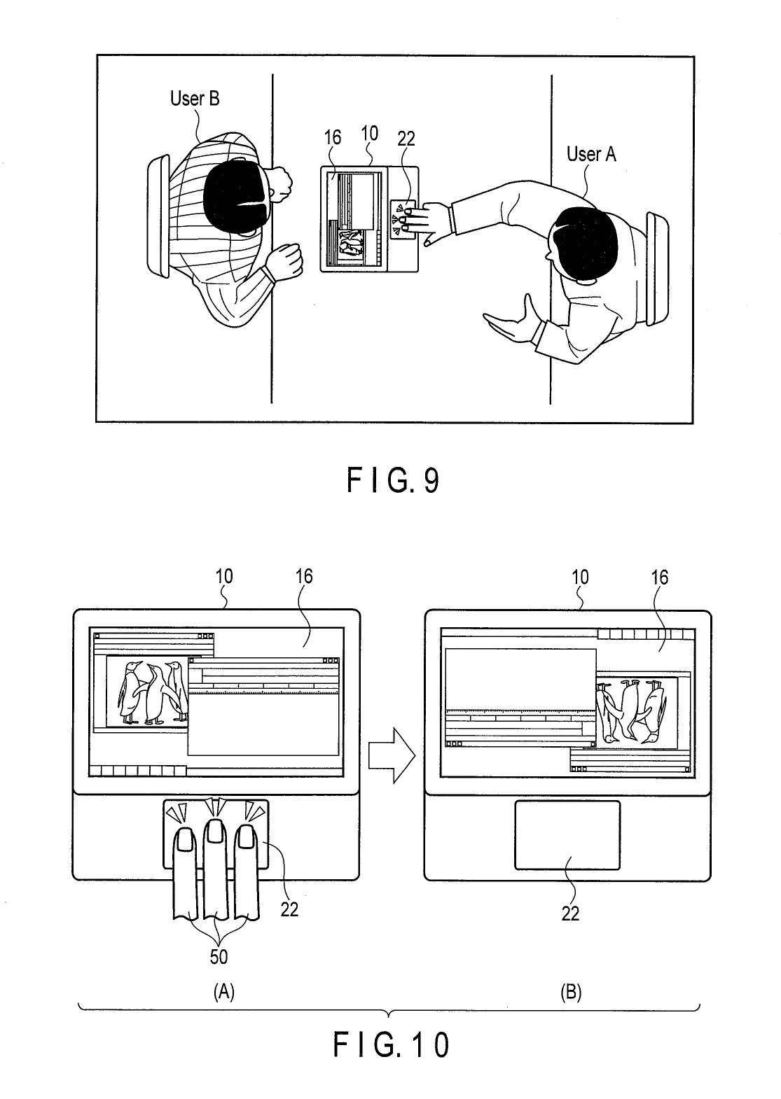

A description is now given of a concrete example illustrated in FIG. 9.

FIG. 9 is a view illustrating, from above, the state in which a user A and a user B sit facing each other with a table interposed, and the personal computer 10 is disposed on the table. In this situation, for example, the user A and user B use the personal computer 10 for preliminary discussions. The personal computer 10 is in the state of the photography mode. In addition, the personal computer 10 is disposed such that the touchpad 22 is located on the user A side, so that the user A can mainly operate the personal computer 10. Usually, the direction of the screen of the touch-screen display 16 (LCD 16a) is set at 0° (normal direction), so that the personal computer 10 may be easily operated by the user A.

In order that the user B may easily view the screen of the touch-screen display 16, the user A executes an input operation of touching the touch pad 22 at three touch positions, as illustrated in FIG. 9.

Parts (A) and (B) of FIG. 10 illustrate the personal computer 10 in FIG. 9. For example, the direction of display of the screen, which is displayed on the touch-screen display 16 as illustrated in part (A) of FIG. 10, is changed, as illustrated in part (B) of FIG. 10, by a touch operation on the touchpad 22 by three fingers 50 of the user A. The example illustrated in part (B) of FIG. 10 shows the case in which the rotational direction is set at “180°” in the setup data 34f.

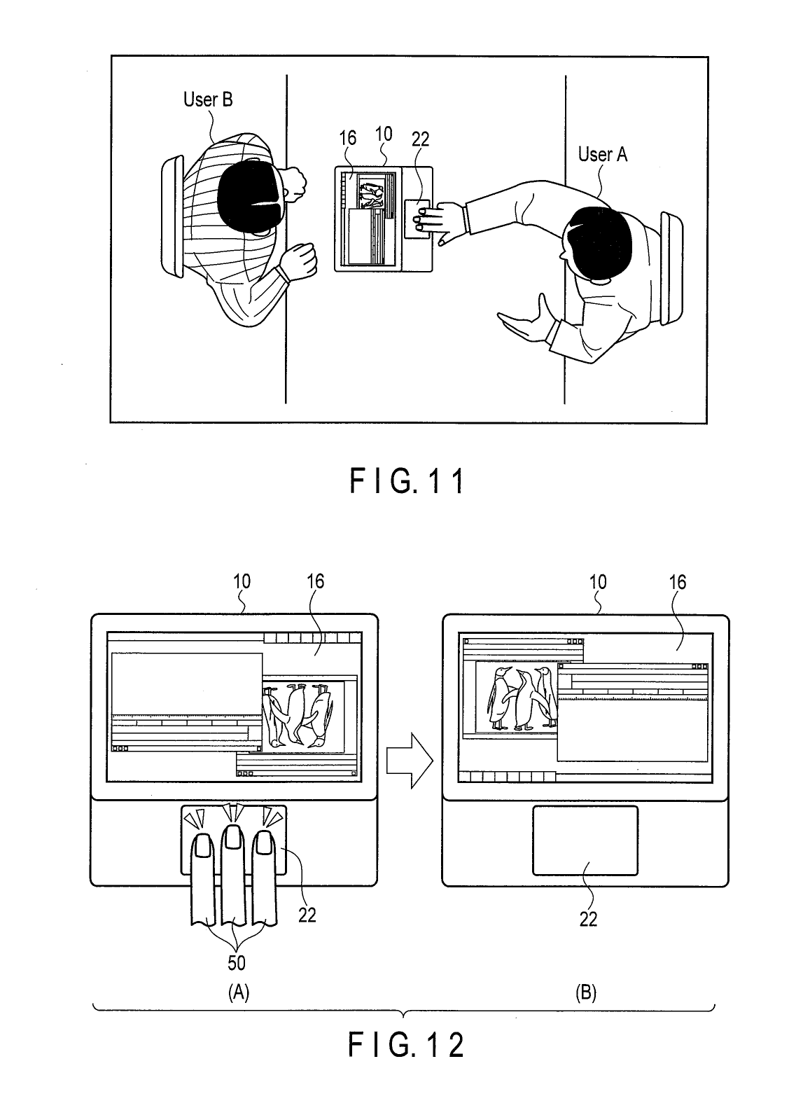

In addition, when the user A wishes to change the direction of the screen, which is displayed on the touch-screen display 16, so that the user A can easily view the screen, the user A executes an input operation of touching the touchpad 22 at three positions, as illustrated in FIG. 11.

Parts (A) and (B) of FIG. 12 illustrate the personal computer 10 in FIG. 11. For example, the direction of display of the screen, which is displayed on the touch-screen display 16 as illustrated in part (A) of FIG. 12, is changed to the normal direction in the user A can easily view the screen, as illustrated in part (B) of FIG. 12, by a touch operation on the touchpad 22 by the three fingers 50 of the user A.

In this manner, by simply executing the operation of touching the touchpad 22 at three positions, the user A can easily change the direction of the screen, which is displayed on the touch-screen display 16, to the direction in which the user B can easily view the screen or the direction in which the user A can easily view the screen.

In the examples illustrated in FIG. 9 and FIG. 11, the user A and user B sit facing each other, and thus the direction of the screen of the touch-screen display 16 is changed over 180° in accordance with the operation of touching the touchpad 22 at three positions. If the user A and user B sit, with a corner of the table interposed, such that the directions of the bodies of user A and user B cross at 90°, the rotational direction may be set at “90° clockwise” or “90° counterclockwise” by the setup function. Thereby, the direction of the screen can be changed over “90° clockwise” or “90° counterclockwise” in accordance with the operation of touching the touchpad 22 at three touch positions.

In addition, when the rotational direction has been set at “90° clockwise” or “90° counterclockwise” by the setup function, the screen direction change application 34e can further change the direction of the screen over “90° clockwise” or “90° counterclockwise” from the already changed direction of the screen, each time the input operation of touching the touchpad 22 at three touch positions is executed.

Besides, instead of further changing the direction of the screen over “90° clockwise” or “90° counterclockwise” from the already changed direction of the screen, alternate switching may be made between the direction of the screen, which is changed over “90° clockwise” or “90° counterclockwise”, and the direction at 0° (normal direction) each time the input operation of touching the touchpad 22 at three touch positions is executed (the same as the case of setting of “180°”).

In the above description, when the input operation of touching the touchpad 22 at three touch positions has been executed, the direction of the screen of the touch-screen display 16 is changed.

Alternatively, a direction, to which the direction of the screen is to be changed, may be determined in accordance with a direction in which the three touch positions are moved. For example, in the case where the touchpad 22 was touched at three positions and then the touch positions, while being touched, were moved to the right, the screen direction change application 34e changes the direction of the screen such that the original direction (normal direction) of the screen is rotated over “90° clockwise”.

Furthermore, the above description has been given of the example in which the direction of the screen is changed in units of 90° or 180°. Alternatively, the direction of the screen may be changed such that the direction of the screen is rotated over an arbitrary angle. In this case, for example, in the case where the touchpad 22 was touched at three positions and then the touch positions, while being touched, were moved to the right or the left, the direction of the screen is changed over a rotational angle corresponding to the distance of movement of the touch positions.

The above description is given of the example in which the direction of display of the entire screen, which is displayed on the touch-screen display 16 (LCD 16a), is changed. Alternatively, the direction of display of a specific display area which is displayed on the screen, or various kinds of objects (e.g. icon, symbol, etc.), may be changed by the above-described operation.

In the above description, the direction of the screen, which is displayed on the touch-screen display 16, is changed (e.g. a change over 180°) when the operation of touching the touchpad 22 at three positions has been detected. Alternatively, the direction of the screen may be changed in accordance with other input operations on the touchpad 22. For example, the direction of the screen may be changed when an operation of touching the touchpad 22 at four or more positions, or an operation of varying one or plural touch positions in a predetermined pattern, has been detected as a predetermined input operation on the touchpad 22.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The process that has been described in connection with the present embodiment may be stored as a computer-executable program in a recording medium such as a magnetic disk (e.g. a flexible disk, a hard disk), an optical disk (e.g. a CD-ROM, a DVD) or a semiconductor memory, and may be provided to various apparatuses. The program may be transmitted via communication media and provided to various apparatuses. The computer reads the program that is stored in the recording medium or receives the program via the communication media. The operation of the apparatus is controlled by the program, thereby executing the above-described process.

What is claimed is:

1. An electronic device comprising:
a first housing comprising a touch-screen display;
a second housing comprising a touchpad, the first housing slidably connected to the second housing;
a detector configured to detect an input operation on the touchpad, when the touchpad is exposed; and
a change controller configured to change a direction of a content displayed on the touch-screen display based on detection of the input operation.

2. The electronic device of claim 1, wherein the change controller is configured to change the direction of the content to a first direction based on the detection of the input operation.

3. The electronic device of claim 2, further comprising a setup controller configured to set the first direction, in accordance with a user operation.

4. The electronic device of claim 1, wherein the change controller is configured to alternately change the direction of the content between a first direction and a second direction, each time the input operation is detected.

5. The electronic device of claim 1, wherein the detector is configured to detect an input operation of touching the touchpad at three positions.

6. The electronic device of claim 1, wherein the detector is configured to disable the input operation when the touchpad is covered with the first housing.

7. A display change method for an electronic device comprising a first housing and a second housing, the first housing comprising touch-screen display, the second housing comprising a touchpad, the first housing slidably connected to the second housing, the method comprising:
detecting an input operation on the touchpad, when the touchpad is exposed; and
changing a direction of a content displayed on the touch-screen display based on detection of the input operation.

8. A computer-readable, non-transitory storage medium comprising a computer program configured to be executed by a computer, the computer comprising a first housing and a second housing, the first housing comprising a touch-screen display, the second housing comprising a touchpad, the first housing slidably connected to the second housing, the computer program configured to cause the computer to execute functions of:
detecting an input operation on the touchpad, when the touchpad is exposed; and
changing a direction of a content displayed on the touch-screen display based on detection of the input operation.
